(19) United States
(12) Patent Application Publication
(10) Pub. No.: US 2011/0145693 A1
(43) Pub. Date: Jun. 16, 2011

(54) TRANSFER OF DIGITAL MEDICAL IMAGES AND DATA

(75) Inventors: Sasa Mutic, Crever Coeur, MO (US); Mark Wiesmeyer, Crever Coeur, MO (US); Daniel Low, Los Angeles, CA (US); Ryan Scott Brame, Chesterfield, MO (US); Theresa Wolf, Kirkwood, MO (US)

(73) Assignee: FULCRUM MEDICAL INC., Chesterfield, MO (US)

(21) Appl. No.: 12/964,922

(22) Filed: Dec. 10, 2010

Related U.S. Application Data
(60) Provisional application No. 61/285,309, filed on Dec. 10, 2009.

(51) Int. Cl. G06F 17/00; G06F 3/048

(52) U.S. Cl. 715/233; 715/851; 715/786

(57) ABSTRACT

A system for distributing images creates a self-sufficient, self-consistent medical imaging and other medical information transfer file that contains image files and corresponding data sets that are bundled with an image viewer application. The medical image and data transfer file is prepared using object serialization and contains a deserialization application. The transfer file is created at an origination location and transmitted to a destination device as a packaged file over a computer network. The destination device receives the packaged file from the origination location and executes the viewer application with the image files and the data sets by opening the packaged file alone, without the need to run any other imaging/viewer application at the destination device. The viewer application has image viewing panes, an annotation tool, and image manipulation tools.

### CROSS-REFERENCE TO RELATED APPLICATIONS

This application claims priority from U.S. Provisional Patent Application No. 61/285,309 filed Dec. 10, 2009.

### STATEMENT REGARDING FEDERALLY SPONSORED RESEARCH

Not Applicable.

### APPENDIX

Not Applicable.

### BACKGROUND OF THE INVENTION

1. Field of the Invention

The invention generally pertains to the field of medical imaging and more specifically storage, transfer and viewing of digital medical images and associated diagnostic and treatment data. Medical imaging refers to the techniques and processes used to create images of a body or parts thereof for clinical purposes or medical science. The medical imaging field employs a variety of imaging systems, applications and formats and the ability to transfer and view images and associated data originating from disparate systems is highly desirable.

One application of medical imaging is in the field of radiation therapy (RT). The medical imaging performed thereof is transferred between and among various treatment clinics, referring clinics, treatment and referring medical doctors and other practitioners for treatment of patients and RT research. The invention discloses systems and methods for creation of self-sufficient, self-consistent medical image and diagnostic and treatment data transfer files, enabling the transfer of said files, and viewing of the transferred data.

2. Related Art

Often, clinical applications of medical imaging are characterized as either diagnostic or radiation therapy (RT) imaging.

Commonly, different medical facilities employ protocols such as the Digital Imaging and Communications in Medicine (DICOM) or the Digital Imaging and Communication in Medicine-Radiation Therapy (DICOM-RT) to ensure file compatibility and transferability of medical imaging files. However, such arrangements may require that the receiving party employ a viewer application that is compatible with the originating facility's system. Further, because of the myriad of facility or equipment-specific systems that are used to create the files for transfer, many of which span multiple software generations, a further problem arises in ensuring that the viewer applications are not only able to open certain of the transferred files but rather that the viewer application can open all of the transferred files and accurately present the transferred images and the associated data to the end user.

Currently, viewing of multiple medical data objects (specifically radiation therapy objects) at a remote location can be performed with 1) static images (JPEG, TIFF, PDF, etc.) which do not allow independent manipulation of individual data objects (turn on/off individual objects such as doses, structures, and images, zoom, pan, adjusting of window and level settings), 2) using a specialized viewer software which first needs to be purchased, installed, and supported by the receiving location, or 3) using an internet connection and accessing software which allows viewing of multiple medical data objects and manipulation through the internet connection (an activity usually restricted to authorized personnel). Generic DICOM viewers which can be packaged with the transported medical data do currently exist, but these viewers mainly handle DICOM images and do not support radiation therapy objects. In comparison, as described in detail below and set forth in the claims, the viewer of the present invention supports radiation therapy objects and creates a process for transporting multiple medical data objects and their viewing at the receiving locations, preferably using object serialization. Methods other than object serialization that may be developed or otherwise used in accordance with the teachings of this invention are also included within the scope of the claims.

In the course of a treatment for a patient, the patient's primary care physician may refer the patient to one or more other physicians who are specialists in their fields of medicine, such as oncology, hematology, cardiology, electrophysiology, neurology, orthopedics, nephrology. In other treatment plans, there may be a team of physicians from different medical specialties. Many times, the physicians use different software programs to display images of a patient's anatomy and particular treatment options, and these software programs are typically unique to their specialties. These specialty software programs are typically very expensive and are complex to operate. When a specialist wants the referring physician or other specialists to see particular images of a patient's anatomy along with treatment information superimposed on the images or otherwise embedded into the images, the current options are not satisfactory. Current systems permit specialists to send image files for reviewing on various viewer applications. Other physicians must have the same or a compatible viewing program to open the particular image files. It would be good for the specialist who uses a complete specialty software program to be able to select image files along with data sets corresponding and define the particular state of the image files and corresponding data sets bundled with a simplified and streamlined viewer application so that any other physician who reviews the images will see precisely the same images and data files without variations that could occur by reviewing image files on different image viewers.

### SUMMARY OF THE INVENTION

Described herein are systems and methods for transfer of digital medical images and associated data along with an accompanying viewer application to an end user device/destination.

One embodiment of the invention is generally a system and method for creation and transfer of a self-sufficient, self-consistent medical image transfer file, comprising a bundle of processed medical image and related data file and a viewer application suitable for correctly displaying the medical image and related data file.

Generally, a data server is interfaced with a control logic that is operable to search and/or receive compatible medical image files and related data. At least one of the files is selected, processed and bundled with a viewer application. The file processing of the medical image and related data are preferably performed by object serialization and are bundled with a deserializing application and a viewer application into a self-sufficient, self-consistent medical image transfer file. The deserializing function could alternatively be built into the viewer application.

The system is used to create a self-sufficient, self-consistent medical image transfer file, where an origination operator designates at least one medical image file for processing, and the operator then triggers the file processing to create the medical image transfer file. The transfer file is then made available to a destination operator for viewing of the transferred medical images and related data.

The proposed application allows a clinician to package multiple medical data objects into one self-sufficient, self-consistent file or set of files and transport them to a receiving location for visualization and independent manipulation of individual medical data objects without a need for any specialized viewing software at the receiving location. The proposed application allows visualization and independent manipulation of multiple medical data objects using the bundled viewer application and without a need for any other viewing software or internet connection to viewing software at the remote location. This is accomplished through creation of a self-sufficient and self-consistent file or set of files which allow transport of multiple data objects to a receiving location and provides the means for viewing and independent manipulation of these objects.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates an image transfer path.

FIG. 2 illustrates an image transfer path with a processed image file.

FIG. 3 illustrates a block diagram of an image transfer system.

FIG. 4 illustrates a block diagram of an alternative embodiment of the image transfer system according to the present invention.

FIG. 5 illustrates a block diagram of another alternative embodiment of the image transfer system according to the present invention.

FIG. 6 illustrates a browser screen according to the present invention.

FIG. 7 illustrates a template/packaging screen according to the present invention.

FIG. 8 illustrates an image viewer screen according to the present invention.

FIG. 9 illustrates an image viewer screen showing annotation elements.

FIG. 10 illustrates a general block diagram and flow chart of the present invention.

### DETAILED DESCRIPTION OF THE PREFERRED EMBODIMENTS

The following description of the preferred embodiment(s) is merely exemplary in nature and is in no way intended to limit the invention, its application, or uses.

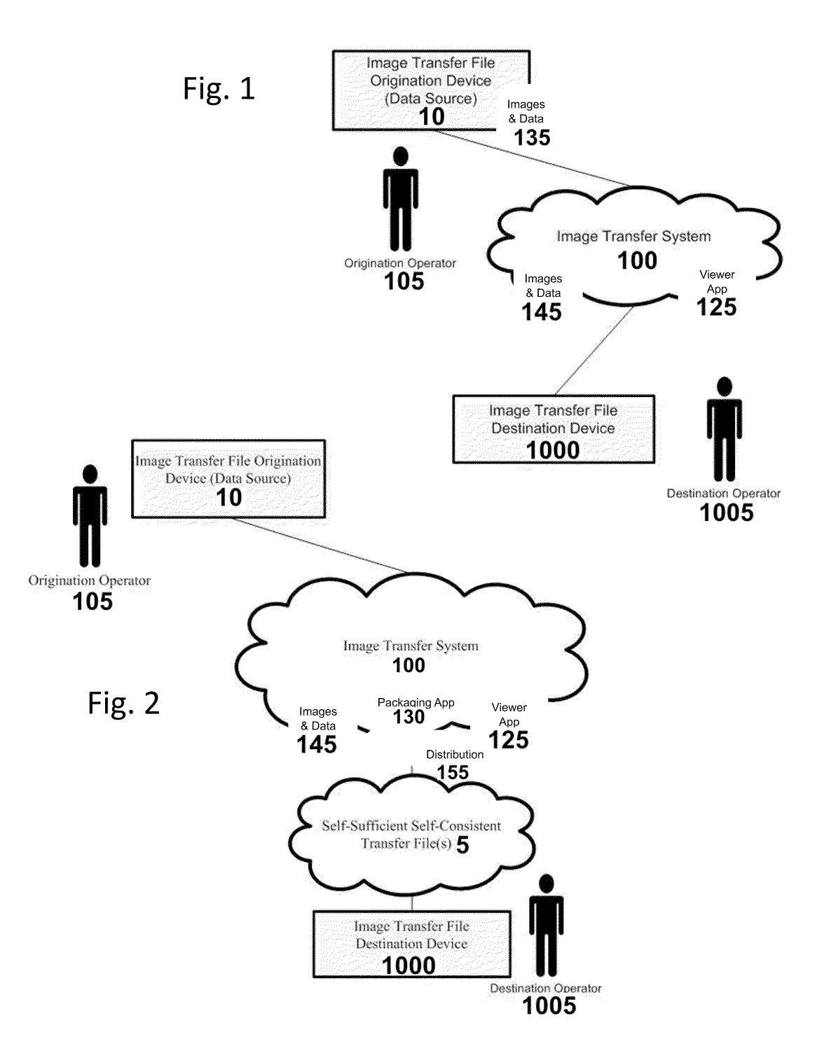

As illustrated in FIG. 1, an embodiment of the invention entails systems and methods allowing an origination operator (OO) 105, located at the origination location to select the images and the associated data 135 produced by the image origination device 10 at the origination location and designate the selected image and data set 145 for transfer via the image transfer system 100 to the destination device 1000. In prior art systems such as those discussed above, the destination device would have to maintain its own application for viewing the images and corresponding data set, and this application may not be the same viewer application that is being used by the origination operator. As illustrated in FIG. 2, the image transfer system 100 uses a packaging application 130 to bundle the selected image and data set 145 with a viewer application 125, creating a self-sufficient, self-consistent transfer file 5 for transfer to a destination device 1000. For the transfer of the file 5, the image transfer system 100 has a distribution module 155 which allows the file 5 to be stored on an electronic medium that is physically transferred to the destination device or saved and electronically transferred over a computer network. At the destination location, the system and method provide for an end-user operator (EO) 1005 to activate the transferred viewer application, which in turn allows viewing of the transferred images and data as intended by the OO 105 at the originating location.

System Elements

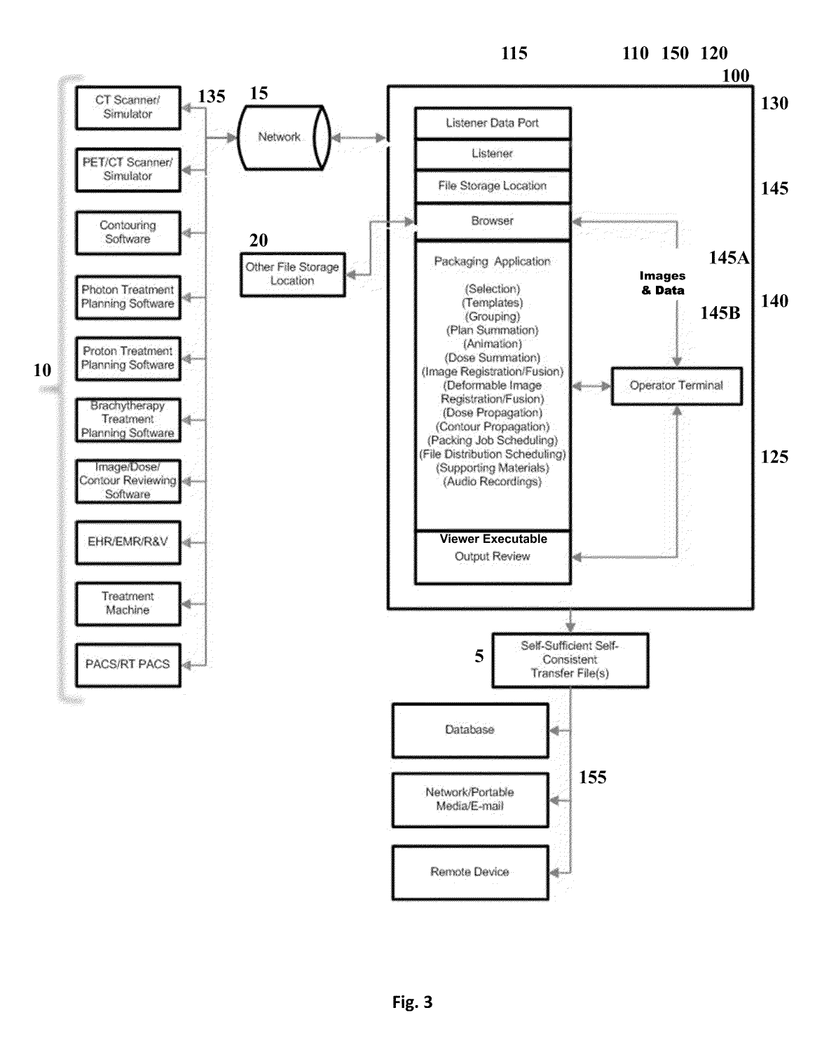

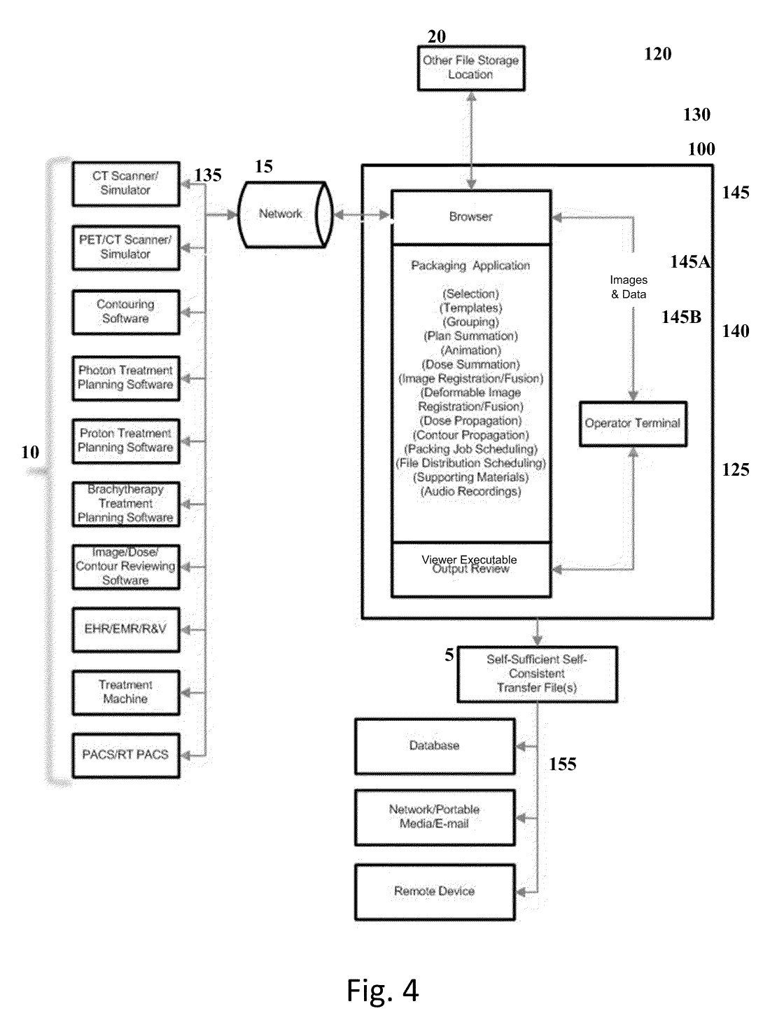

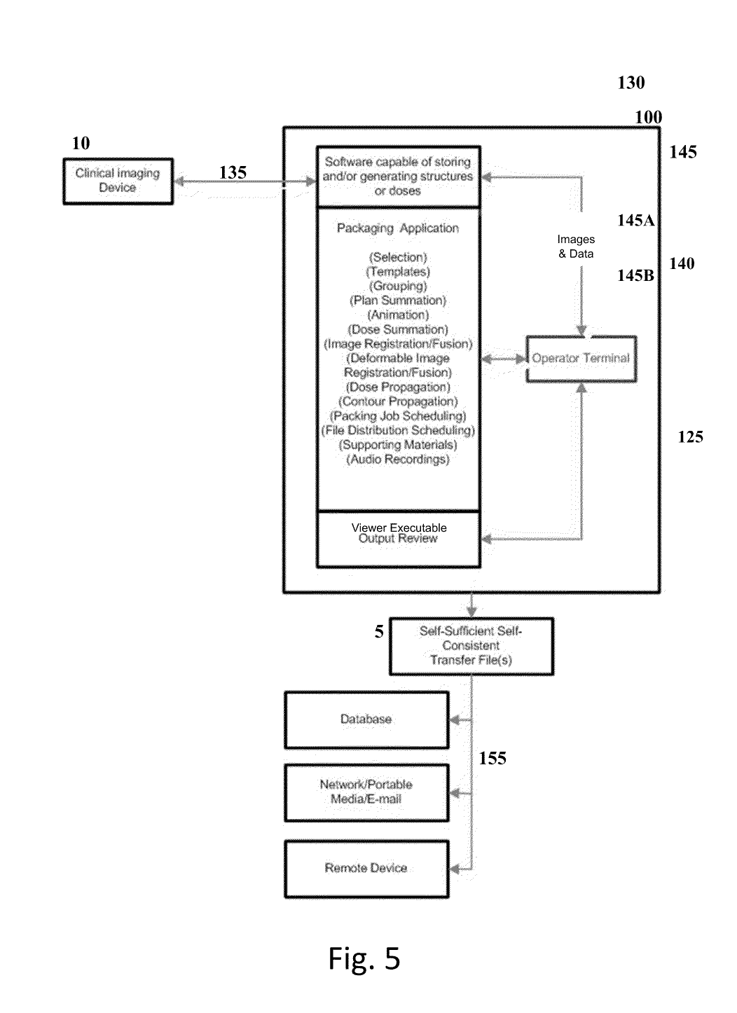

Described herein is a system for transferring medical images and associated data. One embodiment of the image transfer system 100 is illustrated in FIG. 3, where the system 100 is a stand-alone utility, connected to various clinical imaging devices 10 via a computer network 15. In this embodiment, the system 100 employs a data server 110 to receive compatible files 135 that are pushed from clinical imaging devices 10. Another embodiment of the image transfer system 100 is illustrated in FIG. 4, where the system 100 is a stand-alone utility, which through a computer network 15 has a direct access to data 135 stored at various clinical imaging devices 10. In this embodiment the systems 100 employs a browser to search for compatible files stored at remote imaging devices 10. Finally, FIG. 5 shows yet another embodiment where the image transfer system 100 resides directly within one of the clinical imaging devices 10. In this embodiment the compatible files 135 are made directly available to the system 100.

A typical imaging system in a clinical setting may include any number of imaging devices and applications 10 such as medical imaging device (CT scanner, PET/CT scanner, MR scanner, ultrasound machine, etc.), contouring software, image analysis software, image review software, electronic hospital record system, electronic medical record system, record and verify system, hospital information system, PACS, RT [symbol] PACS, radiation therapy planning software, or a radiation therapy machine. All of these are defined as data sources 10 without any limitation which supply the image transfer system 100 with data and compatible files 135 which may include image files and corresponding data sets. Generally, within a clinical setting these devices and applications would be communicatively connected via a data network 15 to allow connecting of any number of software applications, imaging devices, databases, control terminals, etc.

The image transfer system 100, as illustrated in FIGS. 3, 4 and 5, generally includes a packaging application 130 that bundles a viewer application 125 with image files 145A and corresponding data sets 145B that an operator selects through an operator terminal 140 at an origination location. As described below with reference to the various embodiments of the system 100, the image files 145A can include two-dimensional cross-sectional views of one or more three-dimensional structures, one or more three-dimensional views of the structures, and/or time-dependent views of animated structures. Also, as explained below, the data sets 145B that correspond with the image files 145A may be structure sets, plan sets, and/or treatment sets.

In one embodiment, the image transfer system 100 is communicatively connected to the imaging system 10 via the data network 15 through a data server 110, such as a DICOM listener. The data server 110 preferably receives data files 135 from the imaging system 10 using the TCP/IP protocol and provides access to data generated by data sources 10 in the clinic and outside of the clinic 20.

The data server 110 provides a storage service. The data server 110 listens to one or more data ports 115 for which it was configured, waiting to receive messages from any data source 10 that is communicatively configured via a data port 115. Typically, the messages the data server 110 will receive will be requests to store data, for example CT images, MR images, RT structure sets, RT plans and RT doses. These requests can come from a variety of applications and devices 10 including but not limited to medical imaging devices (CT scanner, PET/CT scanner, MR scanner, ultrasound machine, etc.), contouring software, image analysis software, image review software, electronic hospital record system, electronic medical record system, record and verify system, hospital information system, PACS, RT-PACS, radiation therapy planning software, radiation therapy machine, and other medical devices. Upon receipt of such a request, data server 110 will identify the sender, validate the request, negotiate a transfer syntax with the sender, receive the data and then write the data to a file or set of files in a directory configured to serve as the repository for the data server 110. The data server 110 acknowledges receipt of the data when the data has been received and written.

The image transfer system further consists of a packaging application 130 and operator terminal 140. The operator terminal 140 allows selection of data 145 through browser module 120 to be processed by the packaging application 130. The processed file is a self-sufficient self-consistent image transfer file 5 which allows viewing of medical images and associated data at the destination device 1000 without a need for any other specialized image viewing software.

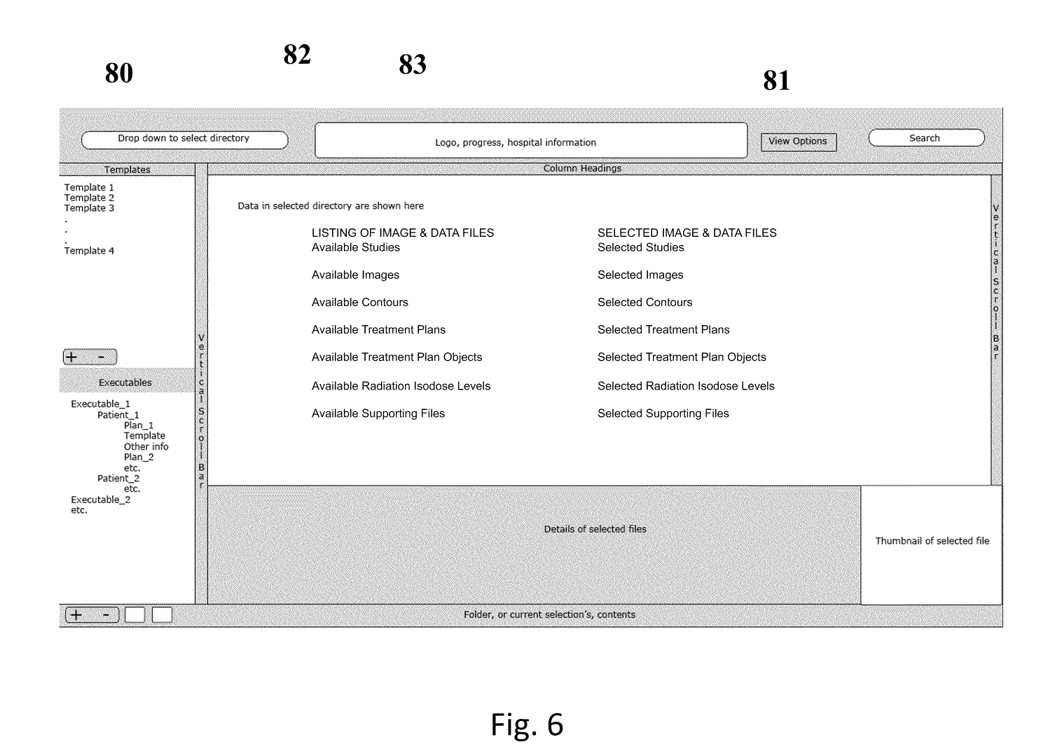

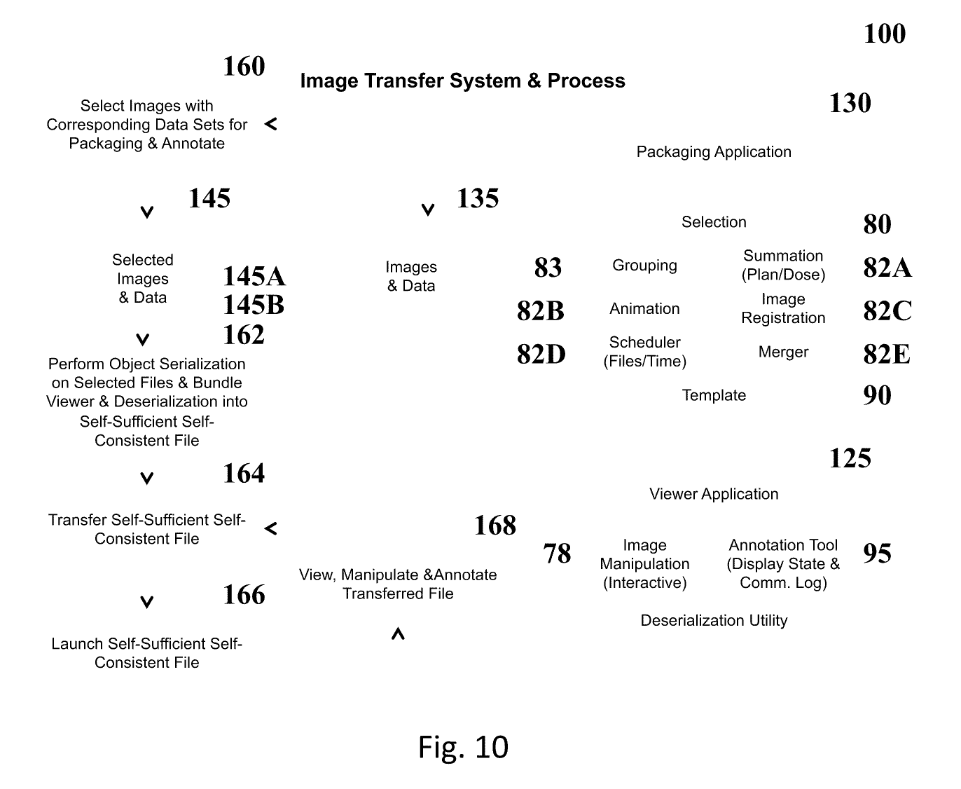

As described below in further detail, the OO 105 may access packaging application 130 via the operator terminal 140 to: 1) specify data to be processed into a self-sufficient self-consistent file(s) 5, 2) specify which data is to be excluded from the self-sufficient self-consistent file(s) 5, and 3) perform additional processes on the selected data like: application of templates, grouping of data, radiotherapy plan summation, creation of animated objects from data which is amenable to animation, radiation dose summation, medical image registration or fusion, deformable medical image registration or fusion, propagation of radiation doses through various sets of medical images, propagation of contours through various sets of medical images, scheduling of packaging jobs, scheduling distribution of packaged files, attachment of supporting documents with the self-sufficient self-consistent file(s) 5, attachment of audio recordings with the self-sufficient self-consistent file(s) 5, inclusion of ancillary information by whatever means available (e.g. textual entry, file parsing, etc.), creation of graphical and/or textual annotations which will restore the viewing display parameters at the destination device 1000 for the destination operator 1005 to the same state as was viewed by the origination operator 105 when the annotation was created by the image transfer system 100 on the image origination device 10 at the origination location. The functions performed by the various modules in the packaging application 130, including the bundled viewer application 125, are listed in FIGS. 3-5 and FIG. 10 and are discussed below with reference to more detailed illustrations of FIGS. 6-10.

The packaging application 130 provides a means for selection of objects, as particularly illustrated in a browser screen view of selection module 80, FIG. 6, that will be included in the packaged file 5, i.e., the processed transfer file(s) 5. This selection module 80 includes selection of studies, images, contours, treatment plans, treatment plan objects, radiation isodose levels and supporting files from data available in directory listing 81. It is often desirable not to include all available images, contours, treatment plans, treatment plan objects, and supporting data in the transfer files. The selection module 80 in the image transfer system 100 allows the OO 105 to select and designate only the desired images and associated data for processing and transfer. The packaging application 130 allows the operator to define which objects will be included in the transfer file(s) 5.

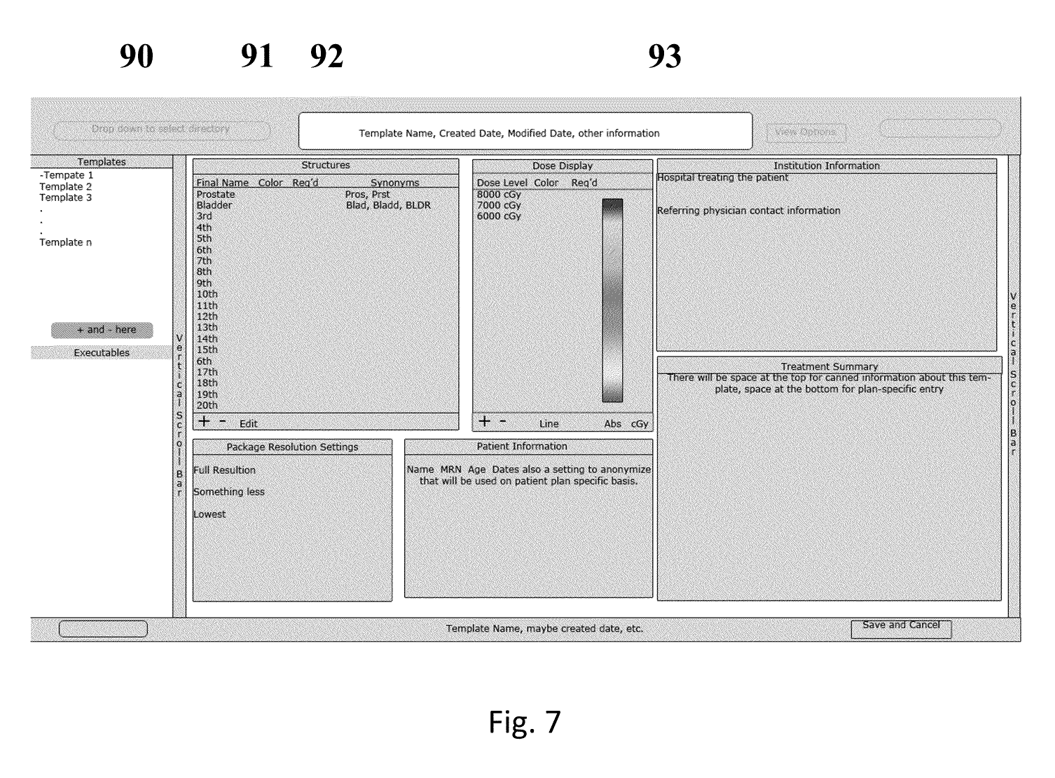

The packaging application 130 may include template creation/editing means (templates) 90, as particularly illustrated in FIG. 7, which the operator may access via the operator terminal 140. The templates 90 may feature a template listing 91 as a means for traversing between multiple templates. The templates 90 may be employed to create automated protocols for processing of image files and associated data to create self-sufficient self-consistent file(s) 5 by applying preset processing rules for studies, images, plans, contours, radiation isodoses, prescriptions, treatment orders, treatment plan objects, and supporting files. In one embodiment, the templates 90 further allow automation of selection of studies, images, and associated treatment data to be processed for transfer, along with the specification of the initial display parameters for viewing at the receiving location/device 1005. The templates 90 allow rule setting for processing of multiple treatment plans and how these will be presented in the processed self-sufficient self-consistent file(s) 5. In one embodiment, the templates 90 allow automation of selection and renaming of contours 92 to be included in the processed transfer file or set of files. The templates 90 could further allow automation of defining how radiation dose distributions and isodoses 93 will be presented in the final self-sufficient self-consistent file(s) 5 and viewed at the destination location. The templates 90 may allow automation of selection of supporting files to be included with the processed self-sufficient self-consistent file(s) 5.

The packaging application 130 may include a grouping capability 83 as illustrated in selection module 80, FIG. 6. When multiple image sets, treatment plans, dose distributions, contours, supporting documents, or other “packageable” information are available, the packaging application 130 may employ grouping of these objects in logical groups based on their relationship in the patient treatment planning or treatment process. Medical patient treatments may consist of several courses of therapy or a single course of therapy. Each course of therapy may contain several different or modified treatments or treatment types. The medical data for these treatments needs to be organized in logical groups and ordered to allow physician or other clinical staff to efficiently understand the delivered therapy or plan of delivery and reconstruct timing and order of patient treatments.

In one embodiment, the operator may engage the grouping capability 83 of the packaging application 130. Such an engagement may be a manual function that is selected by an operator or an automated function, based on facility-defined rules, which may be overridden by the operator on a case-by-case basis.

The packaging application 130 may include additional functionalities 82 such as a radiation treatment plan summation and combining functionality 82A. Medical patient treatments may consist of several courses of therapy (i.e., Patient_{—}1: Plan 1 & Plan 2) or a single course of therapy (i.e., Patient_{—}2). Each course of therapy may contain several different or modified treatments or treatment types. Dose files from individual treatments or groups of treatments can be summed to demonstrate cumulative dose delivered to patient's anatomy. When multiple treatment plans and dose sets are available, the packaging application 130 may allow summation and combining of these plans and doses. The summation and combining functionality allows selection of individual dose files to be combined and presented during viewing as summed doses.

The packaging application 130 may include an animation capability 82B that allows display of certain image sets and three-dimensional (3D) objects that can be animated. For example, display of 4D-CT images can be animated to demonstrate motion due to patient breathing. Contours, radiation dose distributions, and certain plan objects can be visualized in animated 3D views. The packaging application 130 would facilitate animation of these objects when desired by the operator.

The packaging application 130 may include an image registration capability 82C. When multiple image sets are available, the packaging application 130 allows registration or fusion of these images for the purpose of display in the processed self-sufficient self-consistent file(s) 5. Image registration is the process of transforming the different sets of data into one coordinate system. When desired, image registration can be deformable or elastic to cope with deformation of a patient due to breathing or anatomical changes. The packaging application 130 also allows accepting and displaying registrations created in other systems; additionally, it provides the operator with an option to show the registered images, individual images in their original image coordinate systems or interpolated into arbitrary coordinate systems, all with or without a registration object created from within, or imported from the outside of the system.

Additionally, if multiple image sets are available, and these have been registered, the radiation dose can be overlaid on all registered studies. A dose that was created using one specific study can then be propagated on all other registered studies for evaluation purposes.

The packaging application 130 may include a scheduling module 82D where the OO 105 can program and schedule creation and processing of several transfer files or sets of files at a future time and these transfer sets would then be created according to a desired schedule. The scheduler capability would allow transfer files to be processed in a certain order of execution as specified by the OO 105.

In one embodiment, the packager scheduling capability may be configured to automatically accept certain raw images and data as they arrive via the data server 110 and then based on preset templates 90 and job scheduling rules, to automatically process these files for transfer. The OO 105 may further configure and preset the templates 90 and have the packaging application 130 to automatically accept images and data with predefined identifiers, which trigger a set of automatic processing rules; preset identifiers consisting of referring physician, treatment modality, and other predetermined identifiers. Such files could be processed automatically and made available to the operator for transfer approval.

In one embodiment, the scheduling capability may be further configured to manage distribution of created file(s). The scheduler utility may interface with the distribution module 155 that would allow the OO 105 to define where the files will be distributed after processing. Files can be stored locally, e-mailed, broadcasted, placed on a digital recording medium like a CD or a DVD, placed on a flash memory device, moved to PACS or RT-PACS, or a remote storage location.

The packaging application 130 may also include a merger module 82E to combine other documents relating to patient treatment with the final self-sufficient self-consistent file(s) 5. Such additional documents may include reports regarding medical procedures, diagnostic reports, laboratory reports, or other similar medical data. Supporting documents and files could include any recordable means of conveying information, including audio and video recordings as well.

It will be apparent to a person of ordinary skill in the art that any one or even multiple of the above-described elements of the image transfer system 100 could be utilities, modules or functions provided by applications outside of the image transfer system 100, configured to serve the image transfer system and provide the functionality of a cohesive system as above-described.

In one embodiment, as particularly illustrated in FIG. 3, the browser 120 is configured to browse through a database 150 connected to the data server 110 or other databases 20 of patient medical data objects. The browser 120 is configured to filter the data stored in a database 150 based on patient name, patient ID number, database object type, image series counts, series number, study identifier (ID), study description, study unique identifier (UID), object label, file name, UID, and other similar identifiers.

In another embodiment, as particularly illustrated in FIG. 4, the browser 120 is used to query and retrieve data from the database of a remote system or application 10 like: medical imaging device (CT scanner, PET/CT scanner, MR scanner, ultrasound machine, etc.), contouring software, image analysis software, image review software, electronic hospital record system, electronic medical record system, record and verify system, hospital information system, PACS, RT [symbol] PACS, radiation therapy planning software, or a radiation therapy machine.

In yet another embodiment, as particularly illustrated in FIG. 5, the packaging application 130 and the browser 120 may reside directly within another medical application such as a medical imaging device. In this embodiment, the two elements of the image transfer system, the packaging application 130 and the browser 120, may be employed to package that system's data for transfer. In such a configuration, the browsing tools would be specific to that clinical system. For example the packaging application 130 and the browser 120 could be included with the control software for the CT scanner, PET/CT scanner, MR scanner, ultrasound machine, contouring software, image analysis software, image review software, electronic hospital record system, electronic medical record system, record and verify system, hospital information system, radiation therapy planning software, PACS, RT-PACS, or a radiation therapy machine.

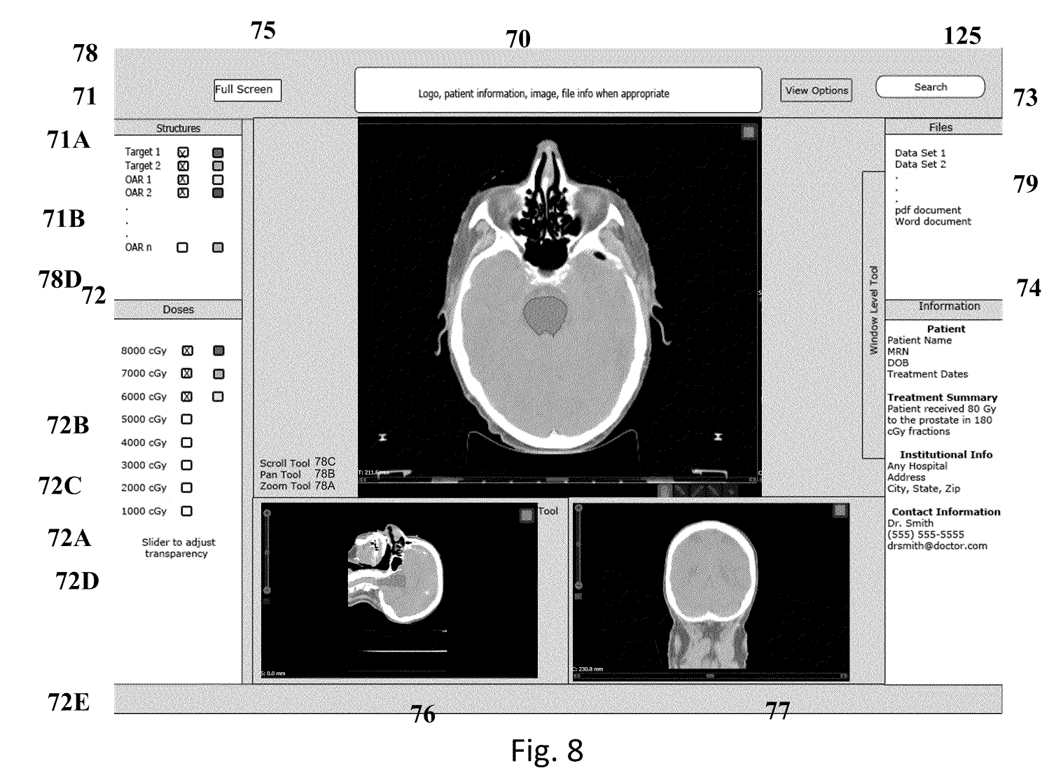

The packager application 130 bundles an image file and corresponding data set 145 and the associated data viewer 125 into the self-sufficient self-contained file(s) 5. The viewer 125 allows EO 1005 to view data packaged by the OO 105. As particularly illustrated in FIG. 8, viewer 125 functionality offers two-dimensional displays of patient anatomy in the viewer display 70. Nominally, these views are cross-sectional views in the three principal axes (axial 75, sagittal 76, and coronal 77). Displays of the cross-sectional views in arbitrary planes are possible as well. These views can be zoomed 78A, panned 78B, and scrolled 78C with the viewer's interactive image manipulation tool 78. The window and level settings for patient images can be adjusted as well with the viewer's window level tool 79. In addition to these relatively generic features for medical image viewing, the viewer's interactive image manipulation tool 78 has specialized display features which allow overlay and manipulation 78D of structures 71 and radiation doses 72 on two-dimensional patient images 75, 76, 77. Each two-dimensional patient anatomy display is capable of displaying: structure outlines 72A which can be individually turned on and off 71B, structure colorwash views 72C, and fused multimodality image views where the transparency of the images from each modality can be adjusted, and radiation isodose lines 72B and adjustable radiation colorwash opacity 72D display.

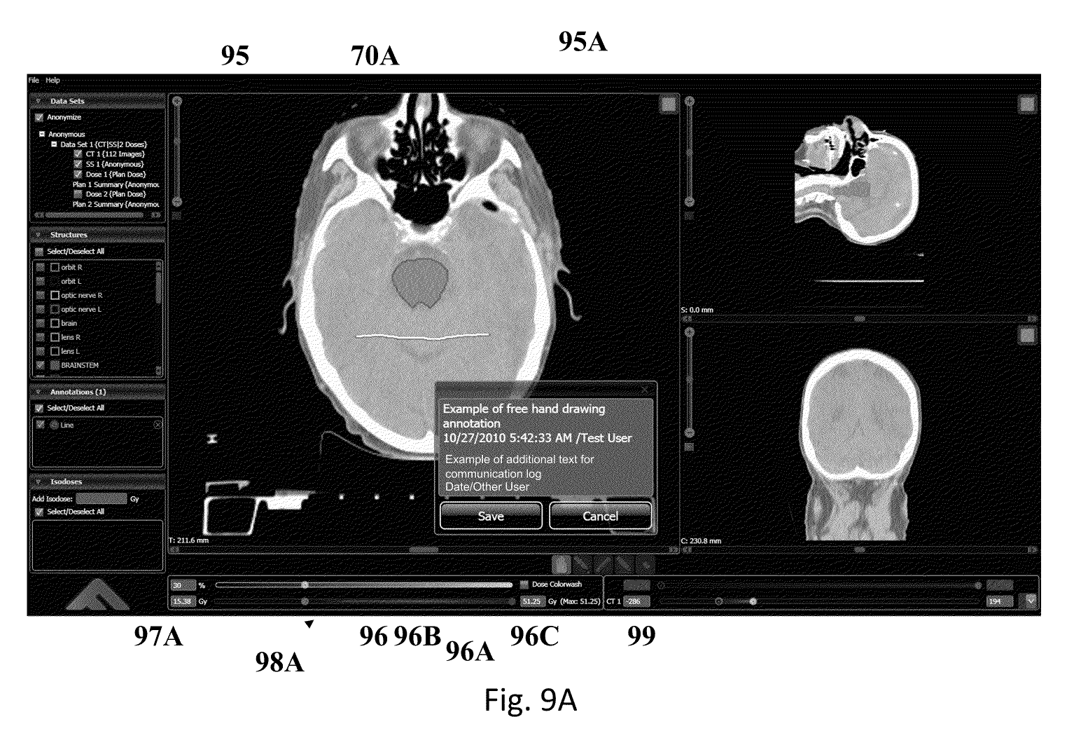

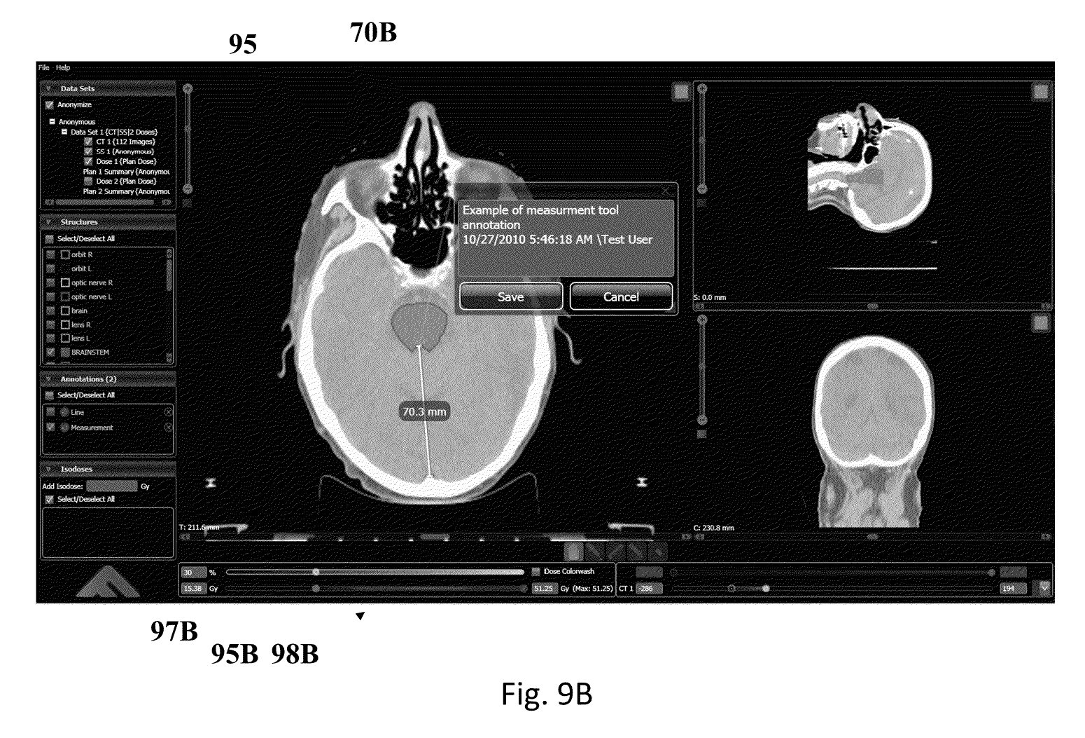

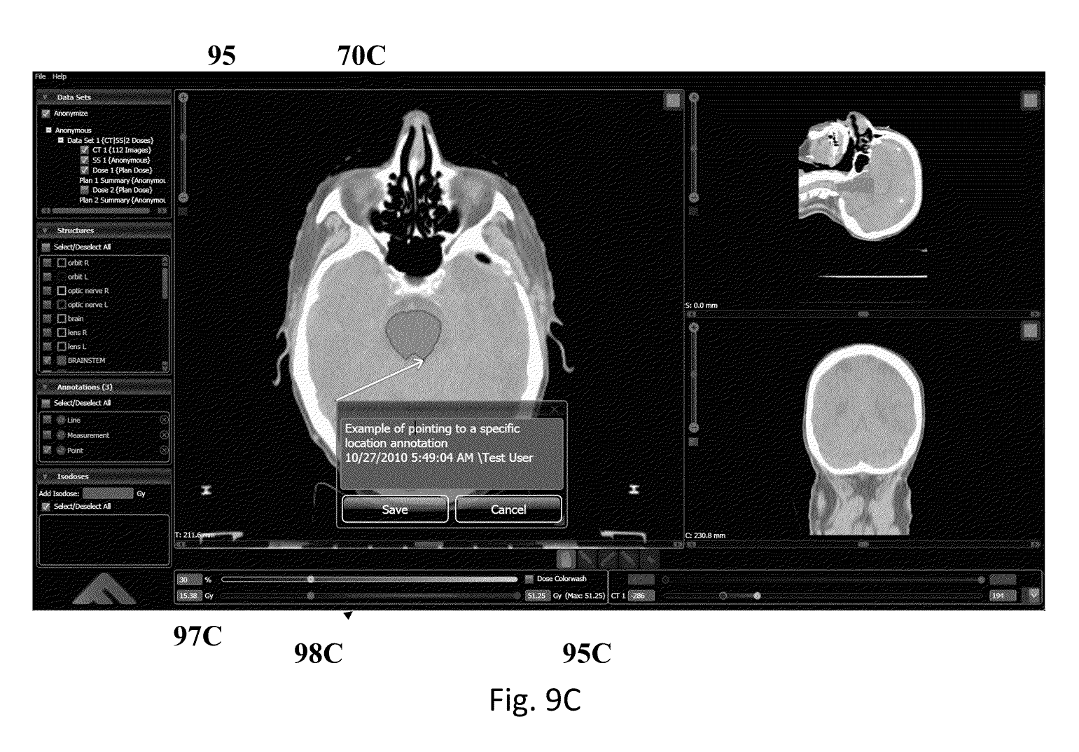

As particularly illustrated in FIGS. 9A, 9B and 9C, the file originator may also use an annotation tool 95 in the viewer application 125 to create annotations 95A, 95B, 95C with attached text 96 and/or other information. For example, a particular text entry for an annotation can include user identification 96A and a date and time stamp 96B. Annotations can be any form of graphical demarcation that communicates originator observations, such as free-hand drawings 95A (FIG. 9A), graphical ruler measurements with distance overlays 95B (FIG. 9B), or arrows pointing to a location or feature 95C (FIG. 9C). As discussed in detail below, the annotation tool 95 can be activated in the viewer application for both the origination operator and the destination operator so that the annotations can be created and appended with additional information.

When the file origination operator creates an annotation 95A, 95B, 95C, the software saves specific features of the image display state 97A, 97B, 97C along with the annotation. These image display state features 98A, 98B, 98C can be images, image pan and zoom, image layout, image window and level, and display of overlayed or imbedded graphics (contours, isodoses, dose colorwashes, secondary images, drawings, text) or any other objects which are contained in the communicated information. When the file destination operator recalls the annotation 95A, 95B, 95C, the software restores the state 97A, 97B, 97C of the image display along with any display features 98A, 98B, 98C which were stored when the annotation was created. As in the cases where the originator communicates via a static screen capture, this feature allows the destination operator to view the annotation in the same display state within which it was created. However, unlike communication with screen shots, according to the present invention, the user has a fully interactive environment within which they can, if desired, change the display state by using the image manipulation tool 78.

Once the destination operator recalls the annotation 95A, 95B, 95C, the software restores the particular state 97A, 97B, 97C of image display 70 to that which was present when the annotation was created, and the destination operator can then proceed to adjust any of the displayed image parameters. For example, in selecting “Line” annotation image display state 97A for the free-hand drawing 95A as shown in FIG. 9A, the annotation tool 95 would restore the particular image display 70A according its particular state when the originator created the annotation 95A. Similarly, the destination operator can recall the originator's measurement annotation 95B or the arrow annotation 95C by selecting the corresponding image display states, “Measurement” 97B or “Point” 97C, which restore the image display accordingly 70B, 70C.

When the displayed image state corresponds with the displayed annotation, the annotation display is bright. When the displayed image state is changed in a specific way from the state was saved with the creation of annotation, the annotation display will indicated by becoming dim or through some other means. The origination operator can create an unlimited number of annotations and each one of these annotations is associated with the respective image display state. Recalling another annotation restores the state of the image display when that annotation was created. When multiple annotations are present, the annotation or annotations that correspond with the current state of the image display will be bright or will in some other way indicate that they correspond with the current image display state. All other annotations that do not correspond to the current image display state can still be visible, but the fact that they were not created in the current display state will be indicated by a difference in how they are displayed (e.g. dimmed, or dashed lines vs. solid lines).

The destination operator can append the annotation, which was created by the origination operator, with additional information 96C. This appended annotation 96C can then be saved with the annotation along with the user name and time stamp of the annotation modification to form a communication log 99 between the operators that is associated with the annotation. The modified file with appended annotations can then be returned to the origination operator or sent to other destination operators as a communication or for additional changes to the annotation.

The destination operator can create new annotations with associated image display states which can then be returned to the origination operator or sent to other destination operators as a communication or for additional changes to the annotation.

Additional tools or functions can be used in combination with the drawing utility, measurement utility and pointer utility of the annotation tool 95. For example, as a part of the pointer utility, clinicians can use a point sample tool to assess properties of individual points in patient images and obtain image and radiation dose values at individual locations. Of course, the annotation tool's measurement utility would interface with a measure tool that is used for measuring distances between points on individual two-dimensional images. It will also be appreciated that the present invention preferably includes a tool for navigating through multiple two-dimensional images simultaneously. With this navigation tool 72E, if a clinician selects a location in one two dimensional view, the software automatically changes views in the other windows to the corresponding location.

Viewer functionality may also offer the ability to display patient anatomy in three-dimensional views along with three-dimensional displays of structures and radiation isodose surfaces. Three-dimensional views may be zoomed, panned, and rotated.

Viewer functionality may allow preview of the available two-dimensional images as thumbnails prior to displaying the fully expanded image. The utility may allow scrolling through thumbnails along with a fisheye tool. The viewer display 70 may show details about individual structures 71A which are segmented on patient anatomy images. This utility allows turning on and off of individual structures one by one or all at the same time. The viewer may display details about individual isodose lines 72A. This utility may allow turning on and off of individual isodoses one by one or all at the same time. The clinician may also have an option to display radiation doses as isodose lines or colorwash clouds. The viewer may display information about patient treatment 74. This includes patient information, prescription information, treatment information, and treatment facility information. The viewer allows selection of data sets to be displayed 73.

The invention can also be used for analyzing or reviewing characteristics of a plan (or of multiple plans, either for a single patient or across a cohort of patients). In this embodiment, the viewer would provide the user with the image, dose and structure data as well as summaries of derivative quantities (e.g. dose volume histograms, various biological quality metrics such as equivalent uniform dose (EUD), modes of variation in doses, anatomy or structure, etc.) and visualization configurations consistent with the desired comparison. The summaries could be generated by an external system or from within the invention using a combination of data selection and data processing tools.

In comparing plans, either alternate plans for a single patient or different plans from a cohort of patients, the viewer would provide the user with the image, dose and structure data as well as summaries of derivative quantities (e.g. dose volume histograms, various biological quality metrics such as equivalent uniform dose (EUD), modes of variation in doses, anatomy or structure, etc.). The user would be provided with comparative analysis tools (e.g. difference/summation operators such as would be used to subtract/add one data set from/to another, dose comparison, etc.) and visualization configurations (e.g. side-by-side display of patient data, or three windows side-by-side such that one data set is in one window, another in the second, and the difference/sum or comparative view is shown in the third; tiled display of a cohort of data in which the screen is divided into many single panes 75, 76, 77, all of which are controlled by synchronizing the effects of, for example, scrolling or panning) consistent with the desired comparison. The summaries could be generated by an external system or from within the invention using a combination of data selection and data processing tools.

File Processing

In computer science, in the context of data storage and transmission, serialization is the process of converting an object into a sequence of bits so that it can be persisted on a storage medium (such as a file, or a memory buffer) or transmitted across a network connection link. When the resulting series of bits is reread according to the serialization format, it can be used to create a semantically identical clone of the original object.

Objects are the fundamental elements of any object-oriented programming language. An object contains properties (data) and performs services (functions). Object serialization is a mechanism that can be used to persist the state of the object to a given location, in a given format, such that it can be reconstructed or deserialized and consumed by another application running locally or remotely. This mechanism provides several benefits:

Because neither the serializing nor the deserializing application has to implement file or stream input/output (I/O), meaning a set of classes/methods that would output the data in some predefined format and a set of classes/methods that would parse the input based on that predefined format, object serialization results in less programming code. Not only does this result in a smaller executable, it makes the system much easier and safer to maintain and enhances the functionality of the image transfer system 100.

Additionally, in at least one embodiment, there is an option of employing binary serialization as opposed to other serialization methods such as XML, making it impossible to determine what information is contained in the transfer file without employing a tailored deserialization executable, programmed to deserialize files from a specific serializing executable.

Even further, it is possible to configure the deserialization executable so that the EO 1005 would be restricted from editing the information being transferred. This would prevent the use of the viewer for purposes other than those for which it is licensed. It also prevents the possibility of ending up with invalid displays stemming from altered files. For example, in other commercially available RT treatment planning products, it is possible to employ a text editor to alter data files if correct lines are targeted for editing. Such alteration is impossible when object serialization is employed. Because the encoding of the data is by definition serial, it is inherent in any serialization scheme that the extracting one part of the serialized data structure requires that the entire object be read from start to end, and reconstructed. The invention provides for the use of object serialization to ensure that the viewer application at the destination location displays the image and data files as the operator at the origination location intended them to be presented and viewed.

Additionally, object serialization may provide improved performance for transfer of the self-sufficient self-contained medical image file and viewer executable 125. With serialization/deserialization, the majority of the processing is performed within the packaging application 120 and can be performed as a background or batched operation. Within the viewer application 125, the deserialization of objects requires the minimum amount of processing in order to display the transferred images and the associated data, facilitating considerably faster loading and display of the transferred data.

Because the proposed transfer system includes a deserializing application within the self-sufficient self-contained transfer file(s), it removes the need for the EO to have specialized image and associate data display software. Such an arrangement, allows for transfer of images and associated data to any EO and ensuring that the EO will be able to view the transferred images and the associated data in a pre-defined manner. The only requirement being, that the EO has compatible computer hardware.

A tree hierarchy for the image files and data sets is listed in the table below.

Patient 1

| | |
|---|---|
| ∘ | Registered data set (common frame of reference or coordinate |

system)

| § | Patient images (CT, MR, PET) |
|---|---|
| § | Structure sets (patient contours) |
| § | Plans (patient setup information, teletherapy beams, |
| brachytherapy sources, etc.) | |
| § | Dose images |

Patient 2

| | |
|---|---|
| ∘ | Registered data set (common frame of reference or coordinate |

system)

| § | Patient images (CT, MR, PET) |
|---|---|
| § | Structure sets (patient contours) |
| § | Plans (patient setup information, teletherapy beams, |
| brachytherapy sources, etc.) | |
| § | Dose images |

The tree can contain one or more patients, and a patient can have one or more registered data sets. A registered data set can contain one or more types of data. It can contain multiple instances of the same types of data, e.g., multiple structure sets. The contents of the registered data sets can be referred to as data objects.

The packaged file 5 contains the serialized patient tree hierarchy, the serialized fixed data for each data object, and the serialized variable data (state data) for each data object, attachments and the viewer application. The serialized patient tree hierarchy includes the items that are currently selected for viewing. The serialized fixed data is the information that cannot be changed by the user. This information can be saved as serialized objects or may be saved in its original DICOM data format. The fixed data includes raw image information (origin, number of pixels in each dimension, pixel sizes) and patient contour coordinates. The serialized variable data is information that can be changed by the user. The DICOM format also has “presentation state” objects that capture much of this information. The variable data includes the information listed in the table below.

Image window/level information (mapping from raw image values to
display palette)
Image window/level preset (select preset window/level values for
different types of anatomy)
Image opacity
Image palette (we can select different palettes with which to display
PET images)
Image on/off
Patient contour on/off
Patient contour color fill on/off
Dose colorwash thresholds (equivalent to window/level)
Dose colorwash opacity
Dose colorwash on/off
Isodose levels
Isodose on/off
Annotations (measurements, line drawings, labeled points)

One embodiment of the invention employs Microsoft Corporation's “.NET” framework to serialize the image and object data that is designated for transfer and then deserialize the transferred file. A number of other programming platforms readily support object serialization.

In one embodiment of the invention, the operator may direct the transfer system 100 via operator terminal 140, as illustrated in the templates 90, the browser 120 to seek and select desired files from the files that are collected by the data server 110. Within the templates 90, the operator may have numerous options and editing capabilities to format the selected files for transfer and to finally designate the selected and/or formatted file set for transfer. This final designation triggers a serialization function of the packager, where all of the designated images and files are serialized, and then, the serialized files are bundled with one or more executable applications to form a self-sufficient self-consistent file(s) 5 for transfer. The self-sufficient self-consistent file(s) 5 for transfer are then stored, transmitted, or transferred as desired.

One embodiment of the invention would provide for one of the bundled executables to serve as a deserialization and viewing utility for the images and associated data contained in the self-sufficient and self-consistent file or set of files 5. Another embodiment would provide for separate deserialization and viewing executables within a transfer file or set of files 5.

Method of Medical Image File Transfer and Viewing

Described herein are methods for using the image transfer system 100 to transfer medical image files and associated data from an origination location/device 105 to a destination location/device 1000.

The relevant method provides that the origination operator may access the image transfer system via an operator terminal, select images and associated data from the files that are available to the image transfer system 160, edit and arrange the images and associated data as desired, initiate a bundling/packaging sequence of the selected files to create a self-sufficient self-consistent transfer file(s) 162, select a manner of file transfer, and command the system's distribution module to commence the transfer from the image origination location/device to an image destination location device 164.

In one embodiment of the relevant method, the creation of the self-sufficient self-consistent transfer file(s) entails the origination operator engaging the packager application to perform object serialization on the selected medical images and associated data, and then, to bundle the serialized file with a viewer application 125 that is configured to deserialize and display the serialized images and associated data. In another embodiment, the serialized image files and associated data are bundled with multiple executables that provide the deserializing and display utilities 125 or viewing of the serialized files.

Further, the relevant method provides for the end operator to launch the executable application of the self-sufficient self-consistent transfer file(s) and employ the executable to view and interactively manipulate the transferred images and associated data 166 using the viewer functions. As discussed above, the destination operator can also append the annotations and form a communication log that can be sent back to the origination operator or to other destination operators 168 who can then launch the transferred self-sufficient self-consistent file without any further object serialization by the packaging application and also view, interactively manipulate and further annotate the transferred file.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A system for distributing images, comprising:
a set of image files, said set of image files being selected from the group of files consisting of a plurality of two-dimensional cross-sectional views of a three-dimensional structure, at least one three-dimensional view of a structure, a plurality of time-dependent views of an animated structure, and any combination thereof;
a set of data sets corresponding with said set of image files, wherein said data sets are selected from the group of data consisting of structure sets, plan sets, treatment sets, and any combination thereof;
a viewer application that reads and displays said image files and data sets;
a packaging application in operative communication with said image files, said data sets and said viewer application, wherein said packaging application bundles said image files, said data sets and said viewer application into a single packaged file.

2. The invention of claim 1, wherein said image files and data sets are comprised of medical image files and corresponding medical data sets for at least one patient and wherein said single packaged file is comprised of a self-sufficient, self-consistent file, and wherein said packaging application has a selection option defining said medical image files and data sets included in said packaged file and excluding other image files and data sets from said packaged file.

3. The invention of claim 1, further comprising multiple sets of image files and corresponding data sets relating to a plurality of patients, wherein said single packaged file is comprised of said multiple sets for said plurality of patients.

4. The invention of claim 1, wherein said viewer application comprises an annotation tool, and an image manipulation tool selected from the group consisting of a scroll tool, a pan tool, a zoom tool, a rotating tool, a measurement tool, a navigating tool for a plurality of image viewing panes, an image/data-on/off selection tool, and any combination thereof.

5. The invention of claim 1, wherein said viewer application comprises an annotation tool and wherein said packaged file comprises an annotation created by said annotation tool.

6. The invention of claim 5, wherein said annotation tool defines an image display state corresponding with said annotation, and wherein said annotation is selected from the group consisting of a drawing, a point sample, a measurement, and any combination thereof.

7. The invention of claim 6, further comprising a wherein said annotation is further comprised of an appended annotation forming a communication log.

8. The invention of claim 1, wherein said viewer application comprises an interactive image manipulation tool, said interactive manipulation tool comprising an overlay of structures on a display of said image files.

9. The invention of claim 8, wherein said interactive manipulation tool is further comprised of an overlay of radiation doses on a display of said image files, wherein said radiation dose overlay is selected from the group consisting of a selectable isodose line, a colorwash view range and a colorwash transparency adjustment.

10. The invention of claim 1, wherein said packaging application comprises a plurality of templates defining automated protocols for processing said image files and corresponding data and wherein said packaged file is comprised of an object serialization format.

11. The invention of claim 1, wherein said packaging application comprises a selection module, wherein said selection module designates said image files and corresponding data sets for inclusion in said packaged file, and wherein said packaging application fixes a state of said image files and said data sets in said packaged file for a display state that a receiver of said packaged file can change according to said viewer application.

12. The invention of claim 1, wherein said packaging application further comprises a scheduling module, said scheduling module defining a time for a transfer of said packaged file.

13. The invention of claim 1, wherein said packaging application further comprises a summation module, wherein said summation module sums a plurality of dosages for a patient.

14. The invention of claim 1 further comprising a deserialization function bundled into said packaged file and a distribution module providing a communication of said packaged file via at least one of a digital recording medium and a transmission over a computer network from said distribution module at an origination location, wherein said deserialization function is selected from the group consisting of a deserialization application separate from said viewer application and a deserialization utility within said viewer application.

15. The invention of claim 14 further comprising a destination device in networked communication with said distribution module, wherein said destination device receives said packaged file from said origination location and executes said viewer application with said image files and said data sets by opening said packaged file alone, without the need to run any other imaging/viewer application at said destination device.

16. The invention of claim 1 further comprising a plurality of supporting documents associated with said image files and corresponding data sets and a merger module attaching said supporting documents into said packaged file.

17. A system for distributing medical image files, comprising:
a set of medical image files, said set of medical image files being selected from the group of files consisting of a plurality of two-dimensional cross-sectional views of a patient, at least one three-dimensional view of a patient, a plurality of time-dependent views of an animated patient, and any combination thereof;
a set of data sets corresponding with said set of image files, wherein said data sets are selected from the group of data consisting of structure sets, plan sets, treatment sets, and any combination thereof;
a viewer application that reads and displays said medical image files and corresponding data sets;
a packaging application in operative communication with said medical image files, said data sets and said viewer application, wherein said packaging application bundles said medical image files, said data sets and said viewer application into a single packaged file.

18. The invention of claim 17, wherein said single packaged file is comprised of a self-sufficient, self-consistent file, and wherein said packaging application has a selection option defining said medical image files and data sets to be included in said packaged file and excluding other image files and data sets from said packaged file.

19. The invention of claim 17, further comprising multiple sets of medical image files and corresponding data sets relating to a plurality of patients, wherein said single packaged file is comprised of said multiple sets for said plurality of patients, and wherein said packaged file is comprised of an object serialization format.

20. The invention of claim 17, wherein said viewer application comprises an annotation tool and an image manipulation tool selected from the group consisting of a scroll tool, a pan tool, a zoom tool, a rotating tool, a measurement tool, a navigating tool for a plurality of image viewing panes, an image/data-on/off selection tool, and any combination thereof.

21. The invention of claim 17, wherein said viewer application comprises an annotation tool and wherein said packaged file comprises an annotation created by said annotation tool, wherein said annotation is selected from the group consisting of a drawing, a point sample, a measurement, and any combination thereof, and wherein said annotation tool defines an image display state corresponding with said annotation.

22. The invention of claim 17, wherein said medical image files and data sets are selected from a group of sources consisting of treatment planning software, treatment delivery devices, computed tomography (CT) scanners, positron emission tomography (PET) scanners, magnetic resonance (MR) scanners, contouring software, photon treatment planning software, proton treatment planning software, brachytherapy treatment planning software, image/dose/contour reviewing software, picture archiving and communication systems (PACS), picture archiving and communication systems radiation therapy (RT-PACS), and any combination thereof, and wherein said packaging application is selected from the group of applications consisting of a stand-alone utility networked to a database in communication with said sources, a browser networked to a plurality of databases associated with each of said sources, and an integrated utility residing within one or more of the sources.

23. The invention of claim 17, wherein said packaging application comprises a selection module, wherein said selection module designates said medical image files and corresponding data sets for inclusion in said packaged file.

24. The invention of claim 17 further comprising a plurality of supporting documents relating to said medical image files and corresponding data sets, a merger module attaching said supporting documents into said packaged file, a deserialization function bundled into said packaged file, a distribution module providing a communication of said packaged file over a computer network, and a destination device in networked communication with said distribution module, wherein said destination device receives said packaged file from said communication of said distribution module and executes said viewer application with said image files and said data sets by opening said packaged file alone, without the need to run any other imaging/viewer application at said destination device.

25. A method for distributing images, comprising the steps of:
selecting a set of image files from at least one of a plurality of two-dimensional cross-sectional views of a three-dimensional structure, at least one three-dimensional view of a structure, and a plurality of time-dependent views of an animated structure;
selecting at least one data set from at least one of a group of structure sets, a group of plan sets, and a group of treatment sets, wherein said selected data set corresponds with said set of image files;
bundling a viewer application and a deserialization function with said selected set of image files and said corresponding selected data set into a single packaged file; and
transferring said single packaged file from an origination location to a destination device.

26. The invention of claim 25, wherein said selecting steps further comprise the step of excluding other image files and data sets from said packaged file, wherein said image files and data sets are comprised of medical image files and corresponding medical data sets for at least one patient and wherein said single packaged file is comprised of a self-sufficient, self-consistent file, and wherein said destination device executes said viewer application that reads and displays said image files and data sets without using an imaging/viewer application apart from said viewer application.

27. The invention of claim 25, further comprising the steps of receiving a request to store said image files and data sets; identifying a sender of said request; validating said request; negotiating a transfer syntax with said sender; receiving said image files and data sets; and writing said image files and data sets to a directory configured to serve as a repository.

28. The invention of claim 25, further comprising the step of executing said viewer application to view and manipulate said image files and data sets through a plurality of image viewing panes, an annotation tool, and an image manipulation tool selected from the group consisting of a scroll tool, a pan tool, a zoom tool, a rotating tool, a measurement tool, a navigating tool, an image/data-on/off selection tool, and any combination thereof.

29. The invention of claim 25, further comprising the step of creating an annotation before said bundling step and defining an image display state corresponding with said annotation.

30. The invention of claim 29, further comprising appending said annotation after said bundling and transferring steps.
